(19) United States
(12) Patent Application Publication
(10) Pub. No.: US 2008/0310808 A1
(43) Pub. Date: Dec. 18, 2008

(54) PHOTONIC WAVEGUIDE STRUCTURE WITH PLANARIZED SIDEWALL CLADDING LAYER

(75) Inventors: David Michael Fried, Brewster, NY (US); Philip Charles Danby Hobbs, Briarcliff Manor, NY (US); Nancy Carolyn LaBianca, Yalesville, CT (US); Frank Robert Libsch, White Plains, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 11/764,447

(22) Filed: Jun. 18, 2007

(51) Int. Cl. G02B 6/10; C23F 1/02

(52) U.S. Cl. 385/129; 216/24

(57) ABSTRACT

A photonic waveguide structure includes a first photonic waveguide layer located over a substrate. A sidewall cladding layer is located cladding a sidewall, but not covering a top, of the first photonic waveguide layer. A second photonic waveguide layer may be located upon the top of the sidewall cladding layer while contacting, but not straddling, the first photonic waveguide layer. The sidewall cladding layer protects the first photonic waveguide layer from environmental exposure, thus providing enhanced performance of a photonic waveguide structure. A planarizing sidewall cladding layer allows the fabrication of optical chips with multiple layers of lithographically defined devices.

### BACKGROUND

1. Field of the Invention

The invention relates generally to photonic structures. More particularly, the invention relates to photonic waveguide structures with enhanced performance.

2. Description of the Related Art

Microelectronic devices have conventionally included purely electronic devices such as transistors, resistors, capacitors and diodes that may be fabricated within and upon a semiconductor substrate. Such purely electronic microelectronic devices are often connected and interconnected with electrical conductors, to thus provide electrical circuits upon the semiconductor substrate.

As microelectronic fabrication technology has evolved and advanced, the advent of optoelectronic fabrication technology, that includes photonic devices and photonic structures also located upon a semiconductor substrate, has evolved. Photonic devices may include, but are not limited to photoemissive devices such as but not limited to conventional light emitting diodes and laser diodes. Photonic devices may also include, but are also not limited to, photoreceptive devices such as photodiodes and charge coupled devices. In contrast with microelectronic fabrication where microelectronic devices are connected and interconnected with electrical conductors, photonic devices are generally connected and interconnected using photonic coupling devices and photonic waveguides. Photonic waveguides in particular are often linear photonic structures that have specific cross-sectional dimensional requirements and index of refraction requirements for effective transmission of a particular photonic wavelength.

While photonic device fabrication, including in particular photonic waveguide structure fabrication, provides genuine advances and advantages with respect to conventional microelectronic device fabrication including patterned conductor layer fabrication, photonic device fabrication including photonic waveguide structure fabrication, is not entirely without problems. In particular, insofar as photonic waveguide structures are often conventionally located and fabricated upon an exposed surface of a substrate, for purposes of ease in photonic coupling to a photonic waveguide structure, photonic waveguide structures are often quite susceptible to environmental exposure that may lead to compromised performance of a photonic circuit that includes the photonic waveguide structure.

In addition, for photonic waveguide devices to be integrated into a fully developed chip technology, multiple layers of waveguides, active devices, and wiring must be formed in multiple layers. Thus a robust technology is needed for encapsulating waveguides in good quality cladding material and for achieving accurate planarization to facilitate later lithography steps. This is particularly important for antenna-coupled tunnel junction devices, where metal antennas are closely juxtaposed with the top surface of a planarized silicon waveguide, with a thin dielectric layer in-between.

Various, photonic waveguide and related structures having desirable properties, and methods for fabricating the photonic waveguide and related structures, are known in the optoelectronic fabrication art.

For example, McNab et al., in “Ultra-low noise photonic integrated circuit with membrane-type photonic crystal waveguides,” Optics Express, Vol. 11 (22), pp. 2927-39 (3 Nov. 2003), teaches a photonic waveguide structure comprising a silicon material. In particular, the photonic waveguide structure may be efficiently fabricated from a silicon-on-insulator (SOI) semiconductor substrate while using conventional semiconductor fabrication methodology.

In addition, Lin et al., in “Multi-User Hybrid Process Platform for MEMS Devices Using Silicon-on-Insulator Wafers,” 18^{th} IEEE International Conference on Micro Electro Mechanical Systems, MEMS 2005, pp. 516-19, teaches a hybrid surface and bulk micromachining process using silicon-on-insulator substrates for fabricating various structures, including photonic waveguide structures. The process uses doped polysilicon for non-critical structures and single crystal silicon for critical structures.

Further, Hattori et al., in “Heterogeneous Integration of Microdisk Lasers on Silicon Strip Waveguides for Optical Interconnects,” IEEE Photonics Technology Letters, Vol. 18(1), Jan. 1, 2006, pp. 223-26, teaches an optical interconnect between a compound laser and a silicon-on-insulator based strip waveguide.

Finally, Kimerling et al., in Electronic-photonic integrated circuits on the CMOS platform,” Proc. SPIE 2006, Jan. 25-26, 2006, teaches integrated electronic and photonic structures, including waveguide structures, that may be fabricated using CMOS process technology.

Due to their potential for ease in integration with purely electronic microelectronic devices, as well as their reduced size and their high routability, photonic devices and photonic structures are likely to be of continued importance as microelectronic fabrication technology advances. In light of such continued importance, desirable are photonic devices and photonic structures, such as in particular photonic waveguide structures, that may be readily fabricated with enhanced performance.

### SUMMARY

The invention comprises a photonic waveguide structure readily fabricated with enhanced performance. Within the photonic waveguide structure, a photonic waveguide layer that is located over a substrate is sidewall cladded with a sidewall cladding layer that is also located over the substrate. The sidewall cladding layer does not cover a top surface of the photonic waveguide layer. In addition, a top surface of the photonic waveguide layer is typically no higher than a top surface of the sidewall cladding layer. The photonic waveguide structure in accordance with the invention thus provides a photonic waveguide structure where a photonic waveguide layer does not stand alone and rise above a substrate. When such a photonic waveguide layer within a photonic waveguide structure does stand alone and rise above a substrate absent an adjoining sidewall cladding layer, the photonic waveguide layer within the photonic waveguide structure is susceptible to environmental induced damage that may compromise the performance (i.e., including but not limited to yield and reliability) of the photonic waveguide structure.

The photonic waveguide structure in accordance with the invention may be fabricated while using a hard mask layer that serves sequentially as: (1) an etch mask for etching a photonic waveguide material layer located over a substrate to form a photonic waveguide layer located over the substrate; and (2) a planarizing stop layer when planarizing a blanket sidewall cladding layer located over the hard mask layer and the photonic waveguide layer to form the sidewall cladding layer that clads the sidewall of the photonic waveguide layer, but does not cover the top surface of the photonic waveguide layer or the hard mask layer.

A particular photonic waveguide structure in accordance with the invention includes a first photonic waveguide layer located over a substrate. This particular photonic waveguide structure also includes a sidewall cladding layer located cladding a sidewall of the first photonic waveguide layer. A top surface of the first photonic waveguide layer is not covered by the sidewall cladding layer.

A particular method for fabricating the photonic waveguide structure includes etching a photonic waveguide material layer located over a substrate, while using a hard mask layer located upon the photonic waveguide material layer as an etch mask, to provide a photonic waveguide layer located interposed between the hard mask layer and the substrate. This particular method also includes forming a blanket cladding layer over the substrate and covering the hard mask layer and the photonic waveguide layer. This particular method also includes planarizing the blanket cladding layer, while using the hard mask layer as a planarizing stop layer, to form a sidewall cladding layer that clads a sidewall of the photonic waveguide layer but does not cover a top surface of the photonic waveguide layer.

### BRIEF DESCRIPTION OF THE DRAWINGS

The objects, features and advantages of the invention are understood within the context of the Description of the Preferred Embodiment, as set forth below. The Description of the Preferred Embodiment is understood within the context of the accompanying drawings, that form a material part of this disclosure, wherein:

FIG. 1A to FIG. 1E show a series of schematic cross-sectional diagrams illustrating the results of progressive stages in fabricating a photonic waveguide structure in accordance with an embodiment of the invention.

FIG. 2 shows a schematic perspective-view diagram of a photonic waveguide structure generally related to the photonic waveguide structure whose schematic cross-sectional diagram is illustrated in FIG. 1E.

FIG. 3A and FIG. 3B show a schematic plan-view diagram and a schematic cross-sectional diagram of a photonic waveguide structure generally in accordance with further processing of the photonic waveguide structure whose schematic perspective-view diagram is illustrated in FIG. 2.

### DESCRIPTION OF THE PREFERRED EMBODIMENT

The invention, which includes a photonic waveguide structure, and a related method for fabricating the photonic waveguide structure, is understood within the context of the description provided below. The description provided below is understood within the context of the drawings described above. Since the drawings are intended for illustrative purposes, the drawings are not necessarily drawn to scale.

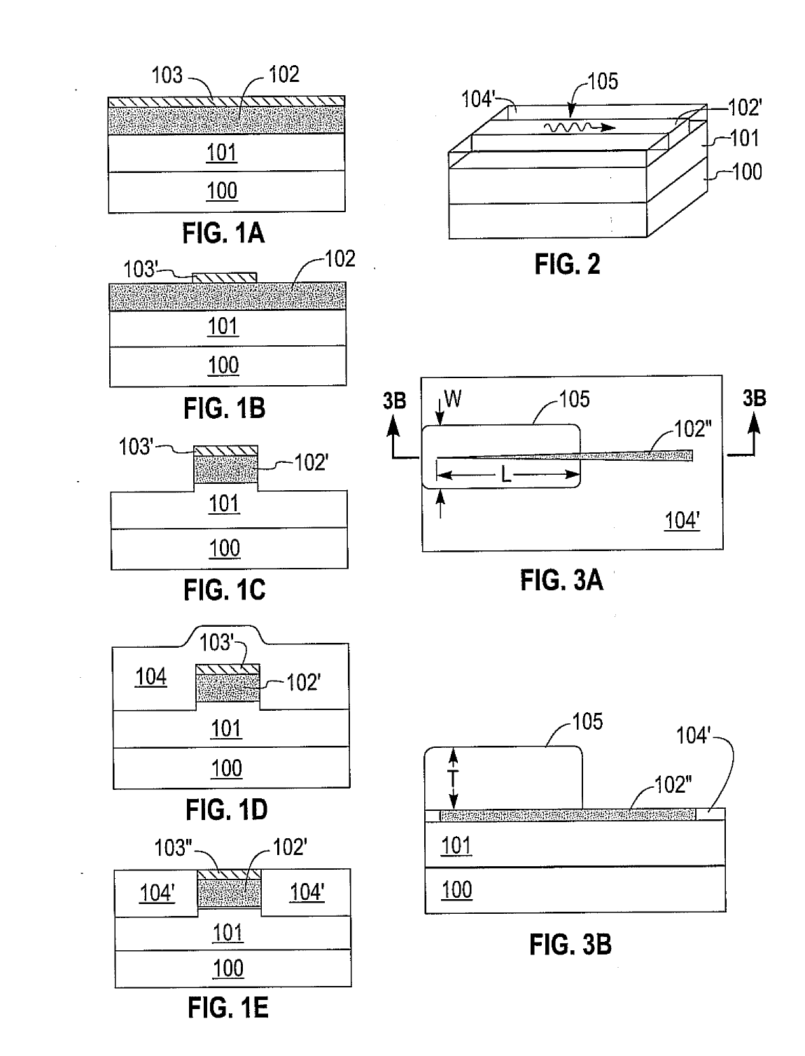

FIG. 1A to FIG. 1E show a series of schematic cross-sectional diagrams illustrating the results of progressive stages in fabricating a photonic waveguide structure in accordance with a particular embodiment of the invention. This particular embodiment of the invention comprises a preferred embodiment of the invention.

FIG. 1A first shows an otherwise generally conventional stack that comprises: (1) a base substrate 100; (2) a dielectric layer 101 located upon the base substrate 100; and (3) a photonic waveguide material layer 102 located upon the dielectric layer 101. Under certain circumstances pertinent to the embodiment, the foregoing generally conventional stack may comprise a semiconductor-on-insulator (SOI) substrate.

The base substrate 100 (which is optional within the instant embodiment when the dielectric layer 101 has a thickness sufficient to provide independent structural integrity to a photonic waveguide structure in accordance with the instant embodiment) may comprise any of several substrate materials. Non-limiting examples of substrate materials include conductor materials, semiconductor materials and dielectric materials. Further non-limiting examples of semiconductor materials include silicon, germanium, silicon-germanium alloy, silicon-germanium-carbon alloy and compound semiconductor materials. Further non-limiting examples of compound semiconductor materials include gallium arsenide, gallium phosphide and indium phosphide semiconductor materials.

The dielectric layer 101 generally comprises a conventional dielectric material, and in particular a conventional dielectric material that has an index of refraction less than a material from which is comprised the photonic waveguide material layer 102. Typically, such an index of refraction will be less than about 3 and more preferably from about 1.4 to about 1.5. Oxides of silicon are preferred dielectric materials for the dielectric layer 101, but such dielectric materials by no means limit the invention. Thus, oxides of other elements, as well as other elemental compositions, alternatively may be used. Examples of such alternative materials of appropriate dielectric constant include silicon nitride. Typically, the dielectric layer 101 has a thickness from about 300 to about 300000 angstroms.

The photonic waveguide material layer 102 is intended to comprise a photonic waveguide material. Candidate photonic waveguide materials may include at least some of the several semiconductor materials from which may be comprised the base substrate 100. Other suitable photonic waveguide materials (i.e., that typically have a refractive index greater than about 2 and more preferably from about 3.4 to about 4.0) are not excluded. Specific non-limiting examples of photonic waveguide materials include silicon materials and indium phosphide materials, of which a silicon photonic waveguide material is preferred. Typically, the photonic waveguide material layer 102 has a thickness from about 300 to about 30000 angstroms.

FIG. 1A finally shows a bard mask layer 103 (or in a less preferred alternative a photoresist mask layer) located upon the photonic waveguide material layer 102. The hard mask layer 103 typically comprises a silicon oxide hard mask material or a silicon nitride hard mask material. Alternatively, the hard mask layer 103 may also comprise a laminate of the foregoing materials (i.e., a silicon oxide material having a thickness from about 30 to about 300 angstroms in turn having located thereupon a silicon nitride material having a thickness from about 100 to about 10000 angstroms).

FIG. 1B shows a hard mask layer 103′ that results from patterning the hard mask layer 103 that is illustrated in FIG. 1A. The hard mask layer 103 is patterned to form the hard mask layer 103′ while using a generally conventional photolithographic and etch method (i.e., that in turn uses a patterned photoresist layer that is not otherwise illustrated within the schematic cross-sectional diagram of FIG. 1B). The etch method typically uses a reactive ion etch that provides effective sidewall definition of the hard mask layer 103′. The resulting hard mask layer 103′ is intended to have aerial dimensions appropriate to aerial dimensions of a photonic waveguide layer that is desired to be patterned from the photonic waveguide material layer 102 while using the hard mask layer 103′ as an etch mask. Such aerial plan-view dimensions for the hard mask layer 103′ may in-part relate to particular intended end uses of a photonic waveguide structure in accordance with the embodiment. For example, and without limitation, end uses in a 1.55 micron optical communications band maybe common.

FIG. 1C shows a photonic waveguide layer 102′ that results from patterning the photonic waveguide material layer 102 while using the hard mask layer 103′ as an etch mask. The photonic waveguide material layer 102 may be patterned to form the photonic waveguide layer 102′ while using etch methods that are appropriate to the photonic waveguide material from which may be comprised the photonic waveguide material layer 102. Such etch methods may include, but are not limited to dry plasma etch methods and aggregates of dry plasma etch methods and wet chemical etch methods.

FIG. 1D shows a sidewall cladding layer 104 that is formed as a blanket layer upon the photonic waveguide structure whose schematic cross-sectional diagram is illustrated in FIG. 1C. The sidewall cladding layer 104 comprises a sidewall cladding material that in turn typically comprises a dielectric material of composition and index of refraction analogous, equivalent or identical to the composition and index of refraction of the dielectric layer 101. More particularly, the sidewall cladding material comprises a silicon oxide material deposited using a high density plasma chemical vapor deposition method. For reasons that will become more apparent in accordance with further disclosure below, the hard mask layer 103′ and the sidewall cladding layer 104 typically comprise different materials (i.e., of different hardness) so that the hard mask layer 103′ may serve effectively as a planarizing stop layer when further processing the photonic waveguide structure whose schematic cross-sectional diagram is illustrated in FIG. 1D. Typically, the sidewall cladding layer 104 has a thickness from about 300 to about 30000 angstroms and an index of refraction from about 1 to about 2.

FIG. 1E shows a sidewall cladding layer 104′ that results from planarizing the sidewall cladding layer 104 within the photonic waveguide structure whose schematic cross-sectional diagram is illustrated in FIG. 1D while using the hard mask layer 103′ as a planarizing stop layer The sidewall cladding layer 104 within the photonic waveguide structure whose schematic cross-sectional diagram is illustrated in FIG. 1D may be planarized to provide the sidewall cladding layer 104′ within the photonic waveguide structure whose schematic cross-sectional diagram is illustrated in FIG. 1E while using methods and materials that are otherwise generally conventional in semiconductor fabrication art. Such planarizing methods may include, but are not necessarily limited to mechanical planarizing methods and chemical mechanical polish planarizing methods. Chemical mechanical polish planarizing methods are particularly common. As is illustrated within the schematic cross-sectional diagram of FIG. 1E, the hard mask layer 103′ may at least in-part be planarized to form a hard mask layer 103″ when planarizing the sidewall cladding layer 104 that is illustrated in FIG. 1D to provide the sidewall cladding layer 104′ that is illustrated in FIG. 1E.

FIG. 1E shows a photonic waveguide structure in accordance with a preferred embodiment of the invention. The photonic waveguide structure includes a photonic waveguide layer 102′ located over a substrate 100. In particular the photonic waveguide layer 102′ contacts a dielectric layer 101. The photonic waveguide layer 102′ is also sidewall cladded with a sidewall cladding layer 104′ that does not cover a top surface of the photonic waveguide layer 102′. Further, within the embodiment that is illustrated in FIG. 1E, a top surface of the photonic waveguide layer 102′ is typically no higher than a top surface of the sidewall cladding layer 104′. As is understood by a person skilled in the art, the hard mask layer 103″ may optionally be removed from the photonic waveguide structure whose schematic cross-sectional diagram is illustrated in FIG. 1E. As is disclosed above, the sidewall cladding layer 104′ clads the sidewalls of the photonic waveguide layer 102′ and thus the photonic waveguide layer 102′ does not stand alone and rise above the base substrate 100 including the dielectric layer 101. Therefore, the photonic waveguide structure that is illustrated in FIG. 1E possesses enhanced performance within the context of at least yield, reliability and integrability.

FIG. 2 shows a schematic perspective-view diagram of a photonic-waveguide structure that corresponds generally with the photonic waveguide structure whose schematic cross-sectional diagram is illustrated in FIG. 1E. FIG. 2 shows the base substrate 100 and the dielectric layer 101. FIG. 2 also shows the photonic waveguide layer 102′ absent the hard mask layer 103″ located thereupon. FIG. 2 also shows the sidewall cladding layer 104′ cladding the sidewalls of the photonic waveguide layer 102′.

Finally, also illustrated in FIG. 2 is a photonic flow direction 105 with respect to the photonic waveguide layer 102′. The photonic flow direction 105 does not in particular limit the embodiment, since a photonic flow within a photonic waveguide layer in accordance with the embodiment or the invention is intended to be in either direction.

FIG. 3A and FIG. 3B show a schematic plan-view diagram and a schematic cross-sectional diagram of a photonic waveguide structure generally in accordance with further processing of the photonic waveguide structure whose schematic perspective-view diagram is illustrated in FIG. 2.

In a first instance, the photonic waveguide structure whose schematic plan-view diagram is illustrated in FIG. 3A and whose schematic cross-sectional diagram is illustrated in FIG. 3B differs somewhat from the photonic waveguide structure whose schematic perspective-view diagram is illustrated in FIG. 2 by the presence of a tapered photonic waveguide layer 102″ rather than the photonic waveguide layer 102′ that is illustrated in FIG. 2 as untapered. A taper of the tapered photonic waveguide layer 102″ has a taper length L from about 150 to about 200 microns, and typically reaches a tapered linewidth as narrow as about 0.05 microns from a starting linewidth of about 0.45 microns.

Similarly, the photonic waveguide structure whose schematic plan-view diagram is illustrated in FIG. 3A and whose schematic cross-sectional diagram is illustrated in 3B also shows a second photonic waveguide layer 106 that is located upon the sidewall cladding layer 104′ and also contacting the photonic waveguide layer 102″ but not straddling (i.e., covering sidewalls of) the photonic waveguide layer 102″.

The particular taper of the tapered photonic waveguide layer 102″ may be effected using sidewall etching and undercutting of a waveguide layer that is initially formed beneath a hard mask layer that itself is tapered in an aerial dimension. Such sidewall etching may be effected using a wet chemical isotropic etchant or a dry plasma trim etch process.

The second photonic waveguide layer 105 may comprise any of several optically compatible photonic waveguide materials that properly optically mate with the first photonic waveguide layer 102″, typically by having a refractive index intermediate between those of the first photonic waveguide layer 102″ and the sidewall cladding layer 104′. Such photonic waveguide materials may include, but are not limited to inorganic waveguide materials, organic waveguide materials and composite waveguide materials that have an index of refraction in an appropriate range for optimal optical coupling. Typically, the second photonic waveguide layer 105 comprises a polymer waveguide material that has a thickness T and a width W that also may in-part be defined by an intended end use of the photonic waveguide structure in accordance with the invention. Again, end uses in a 1.55 micron photonics communication band may be common, but are by no means limiting.

FIG. 3A and FIG. 3B show a photonic waveguide structure generally incident to further fabrication of the photonic waveguide structure whose schematic perspective view diagram is illustrated in FIG. 2. This particular photonic waveguide structure comprises a second photonic waveguide layer 105 located upon the sidewall cladding layer 104′ and also contacting in a linear and offset arrangement a tapered tip of the photonic waveguide layer 102″, but not effectively straddling the photonic waveguide layer 102″. The second photonic waveguide layer 105 may under certain circumstances be used for providing external optical connections while using the waveguide structure whose schematic plan-view diagram is illustrated in FIG. 3A and whose schematic cross-sectional diagram is illustrated in FIG. 3B.

The preferred embodiment is illustrative of the invention rather than limiting of the invention. Revisions and modifications may be made to methods, materials, structures and dimensions of a photonic waveguide structure in accordance with the preferred embodiment, while still providing a photonic waveguide structure in accordance with the invention, further in accordance with the accompanying claims.

1.-6. (canceled)

7. A method for fabricating a photonic waveguide structure comprising:
etching a photonic waveguide material layer located over a substrate, while using a hard mask layer located upon the photonic waveguide material layer as an etch mask, to provide a photonic waveguide layer located interposed between the hard mask layer and the substrate;
forming a blanket cladding layer over the substrate and covering the hard mask layer and the photonic waveguide layer; and
planarizing the blanket cladding layer, while using the hard mask layer as a planarizing stop layer, to form a sidewall cladding layer that clads a sidewall of the photonic waveguide layer but does not cover a top surface of the photonic waveguide layer.

8. The method of claim 7 wherein the hard mask layer comprises a silicon nitride material.

9. The method of claim 7 wherein the blanket cladding layer comprises a silicon oxide material.
